(19) United States
(12) Patent Application Publication
(10) Pub. No.: US 2009/0212101 A1
(43) Pub. Date: Aug. 27, 2009

(54) METHOD AND SYSTEM FOR PROVIDING PRODUCT SAFETY TO A MANUFACTURED ITEM WITH VERIFICATION CODES

(75) Inventor: Cheng Tan, Cupertino, CA (US)

Correspondence Address: VIRTUAL LAW PARTNERS LLP, P.O. BOX 1329, MOUNTAIN VIEW, CA, 94042, US

(73) Assignee: PROVALIDATE, Cupertino, CA (US)

(21) Appl. No.: 12/035,280

(22) Filed: Feb. 21, 2008

(51) Int. Cl. G06F 17/00

(52) U.S. Cl. 235/375

(57) ABSTRACT

In a method and system for providing anti-counterfeit and product safety to a manufactured item, two substantially unique verification codes, one readable and the other hidden, are associated and supplied with the manufactured item. The verification codes are initialized to a first state at a validation service. Either or both codes may be submitted to a validation service for validation for any number of occasions, with the validation service responding with a message appropriate to the current state of the code. When the hidden verification code is exposed and submitted to the validation service for validation, a first successful validation is used as an event that triggers a state transition of both the readable and the hidden verification codes from the first state to a second state.

### BACKGROUND OF THE INVENTION

After manufactured items are released to the distribution chain for sale, threats to product safety include product relabeling, label tampering, intermingling with counterfeits, discovery of problems that warrant actions such as advisories and recalls, and product lifetime expiry. An example of tampering was the discovery in 2003 of relabeled vials of the anemia medication PROCRIT ®. The vials were 2,000 units/mL that had expired, and were relabeled to state 40,000 units/mL, raising the retail price from $25 per vial to $750 per vial. Twenty-five thousand patients were administered the potentially dangerous and weaker doses from the relabeled vials, and investigators found that up to 110,000 vials were compromised.

It is desirable to provide means for users to check on the viability or validity of items. Serial and batch numbers, product expiry dates, and other visible indicia alone are insufficient protection because these can be tampered with or relabeled. A counterfeiter could also mass produce copies of an item, all having valid or manipulated indicia.

### BRIEF SUMMARY OF THE INVENTION

The present invention provides a method and system for providing anti-counterfeit and product safety to a manufactured item, where two substantially unique verification codes, one readable and the other hidden, are associated and supplied with the manufactured item. The verification codes are initialized to a first state at a validation service. Either or both codes may be submitted to the validation service for validation for any number of occasions, with the validation service responding with a message appropriate to the current state of the code. When the hidden verification code is submitted to the validation service for validation, a first successful validation is used as an event that triggers a state transition of both the readable and the hidden verification codes from the first state to a second state.

### BRIEF DESCRIPTION OF SEVERAL VIEWS OF THE DRAWINGS

FIGS. 1A-B shows a flow diagram for an exemplary embodiment.

FIG. 2A shows a state diagram of the readable verification code.

FIG. 2B shows a state diagram of the hidden verification code.

FIG. 2C shows a state diagram of additional state transitions for the readable and hidden verification codes.

FIG. 2D is the state diagram of FIG. 2C with an additional recall state incorporated.

FIG. 3A shows an example of validation processing steps.

FIG. 3B shows exemplary messages that can be returned to the user for different verification code states.

FIG. 4 is a block diagram illustrating an anti-counterfeit and product safety system according to one exemplary embodiment.

FIGS. 5A-C show examples of database tables for tracking the state of the verification codes and for performing validations.

### DETAILED DESCRIPTION OF THE INVENTION

The present invention relates to providing product safety to manufactured items. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention is mainly described in terms of particular systems provided in particular implementations. However, one of ordinary skill in the art will readily recognize that this method and system will operate effectively in other implementations. For example, the systems, devices, and networks usable with the present invention can take a number of different forms. The present invention will also be described in the context of particular methods having certain steps. However, the method and system operate effectively for other methods having different and/or additional steps not inconsistent with the present invention.

The present invention provides a method and system for providing anti-counterfeit and product safety to a manufactured item, where two substantially unique verification codes, one readable and the other hidden, are associated and supplied with the manufactured item. The verification codes are initialized to a first state at a validation service. Either or both codes may be submitted to the validation service for validation for any number of occasions, with the validation service responding with a message appropriate to the current state of the code. The readable code may be used by the supply chain and by prospective consumers, and the hidden verification code may be exposed and validated by the end consumer. When the hidden verification code is submitted to the validation service for validation, a first successful validation is used as an event that triggers a state transition of both the readable and the hidden verification codes from the first state to a second state. The manufacturer or validation service may also transition the state of the verification codes on events like product expiry or on discovery of a problem so that users can be notified when validations are performed.

The verification codes are low-cost, easy to manage, and easy to use. It is sufficient that the manufacturer advertises that these verification codes provide up-to-date information, and validation of the verification codes can be done easily without the need for any specialized scanners or hardware. A protected item that is sold without verification codes, or has verification codes that do not validate correctly will raise a flag, and the item can be rejected, reported, or returned.

The manufacturer gains protection from product relabeling, label tampering, counterfeiting, and other product safety threats, and they have an avenue to disseminate information about the item after it has been released or sold. Any manufactured item can be protected with this method.

Provisioning and Use

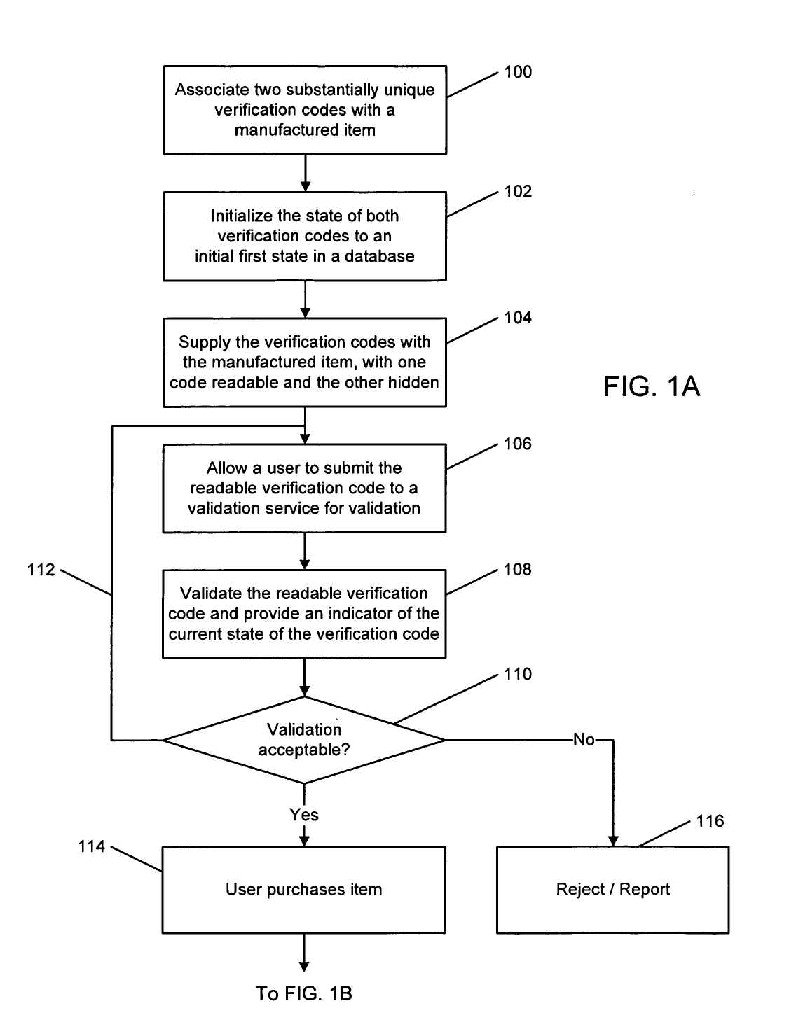

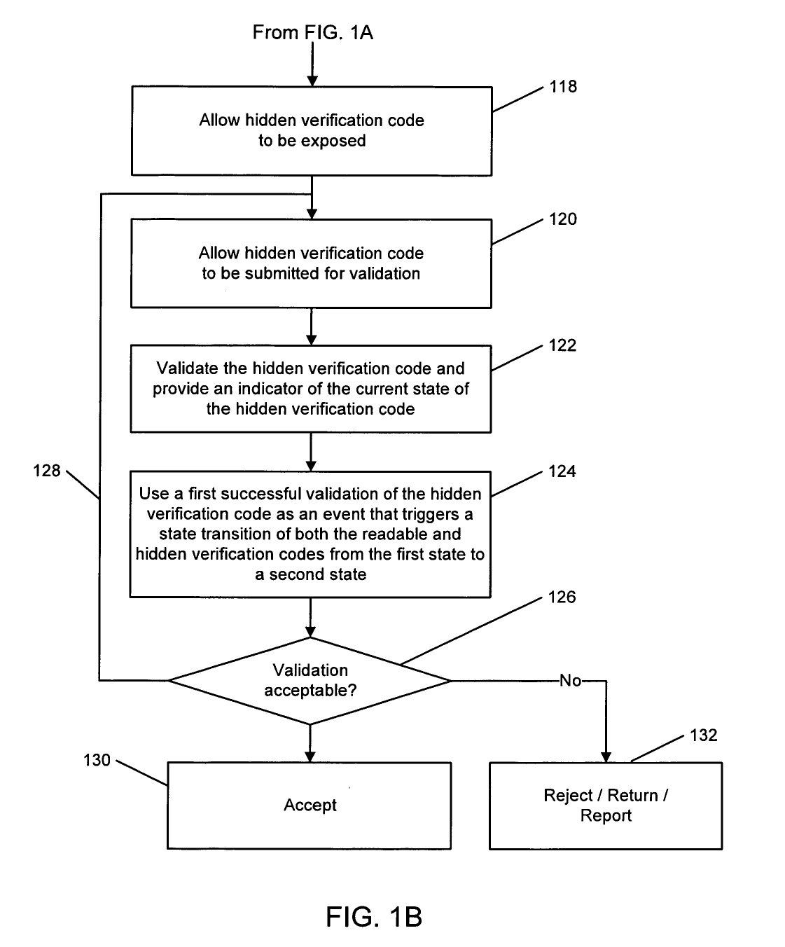

FIGS. 1A-B is a flowchart of an embodiment of a method for providing product safety to a manufactured item using two multiple-use verification codes. The process begins with an entity, such as a manufacturer, a provisioning service, or a validation service associating two substantially unique verification codes with a manufactured item (block 100). The verification codes have an associated state that is maintained by an entity, such as the manufacturer or a validation service, and this state may be stored in a database. The verification codes are initialized to an initial first state (block 102). The state for the verification codes do not need to be separately maintained for each verification code and it may be a single variable that is shared by the pair. In the exemplary embodiment, a shared state variable is used, and the verification codes are initialized to an unvalidated state. In other embodiments, the initial state may be associated with any name or identifier, such as unconfirmed, unexpired, unsold, unverified, and valid, for instance.

The manufactured item may be supplied, e.g., sold, with one verification code readable and the other hidden from view. Hiding of the verification code may be achieved by enclosing the verification code together with the item within sealed and opaque packaging, or it may be placed within a sealed container such as an envelope that is attached to the manufactured item. The verification code may also be hidden by obscuring the code behind scratch-removable material.

A user such as a person in the supply or distribution chain, or a prospective consumer can submit the readable verification code to a validation service for any number of occasions (block 106). In response to the validation service receiving the readable verification code for validation (block 108), the validation service validates the readable verification code, and the user is provided with an indicator (e.g., a displayed message) of the current state of the verification code (block 108). In one embodiment, the validation service that is validating a readable verification code, which is in the initial state, may also indicate to the user that while valid (block 108), confirmation would require validating the additional hidden verification code after the item is purchased.

Step 112 allows the readable verification code to be submitted again for validation. While it is shown following block 110, this should not be taken as a limitation. At any time following block 104, the readable verification code may be submitted for validation, and for any number of times.

If the indicator from the validation service is acceptable, the status of the manufactured item is good, and the user or another consumer may proceed to purchase the item (block 114). If the indicator shows a problem, appropriate action can be taken. For instance, the supply chain can pull the item from sale or the user can reject or report the item (block 116).

Referring now to FIG. 1B, after the item is purchased, the user is allowed to expose the hidden verification code (block 118) and to submit the hidden verification code to the validation service for validation (block 120). In response to the validation service receiving the hidden verification code for validation, the validation service validates the hidden verification code, and the user is provided with an indicator of the current state of the verification code (block 122).

The first successful validation of the hidden verification code is used as an event that triggers a state transition of both the readable and the hidden verification codes from the first state to a second state, such as a validated state (block 124). In the exemplary embodiment, this is a transition from the first unvalidated to a second validated state. In other embodiments, the verification codes may be transitioned to any other type of second state, such as a confirmed, expired, sold, verified, or invalid state, for instance.

If the indicator of the current state of the hidden verification code from the validation service is acceptable, the status of the manufactured item is good and the manufactured item can be accepted (block 130). If the indicator shows a problem, appropriate action can be taken. For instance, the consumer can reject, return or report the item (block 132).

Step 128 allows the hidden verification code to be submitted again for validation. While it is shown following block 126, this should not be taken as a limitation. At any time following the exposure of the hidden verification code (block 118), the hidden verification code may be submitted for validation, and for any number of times.

While block 118 shows exposure of the hidden verification code after purchase, this should not be taken as a limitation. In other embodiments, exposure of the hidden verification code may also be allowed by any of the following situations: as a condition of purchase, after taking possession, before use, and before consumption.

The state transition of both the readable and the hidden verification codes from the first state to the second state serves as an anti-counterfeiting measure. With the first successful validation of the hidden verification code, an indicator such as a message may be provided to the user indicating that the verification code is valid and that it is the first validation. Thereafter, validations performed with either the readable or the hidden verification code while the code is in the second state may result in messages indicating that the verification code has been previously validated, and is no longer valid for an item that is brand new. Counterfeiters will be thwarted by the inability to mass produce items with verification codes that will validate correctly since the codes must not only be known to the validation service, they must also be valid and in the expected state. If counterfeit items should indeed be mass produced with the same valid verification codes, the first successful validation of one of the duplicated hidden verification codes will render all the other copies invalid.

For example, let R12345 and H34567 be the readable and hidden verification codes respectively that are supplied with a manufactured item. (Both codes have been given simplified forms just for this example). If a counterfeiter were to obtain the manufactured item, expose the hidden verification code, and mass produce items with readable verification code R12345 and hidden verification code H34567, the first user that submits hidden verification code H34567 to the validation service would cause the state of both verification codes to transition to a validated state. If other users were to submit either of the two codes that were duplicated and supplied with the other counterfeit copies, the validation service could supply a message saying that the code had been previously validated and is no longer valid for an item that is brand new. This then would be an indicator to the user that something is amiss and they can reject the item if they were expecting to receive an indicator that the item was brand new. Damage from the counterfeit copies would thereby be contained.

Additional Verification Code States

The validation service may transition a verification code to a new state during a validation request, such as with the first successful validation of the hidden verification code as discussed with FIG. 1B.

While not shown in FIGS. 1A and 1B, other significant events may transition the state of the verification codes to different or additional states. If a problem with the product is discovered, the state of the verification codes may be changed so that appropriate indicators can be provided to the user on validation. Examples of other states include advise (to provide a product advisory), recall (to issue a product recall), expired (to coincide with product expiry), and invalid (to reject validations).

State Diagrams and State Indicators

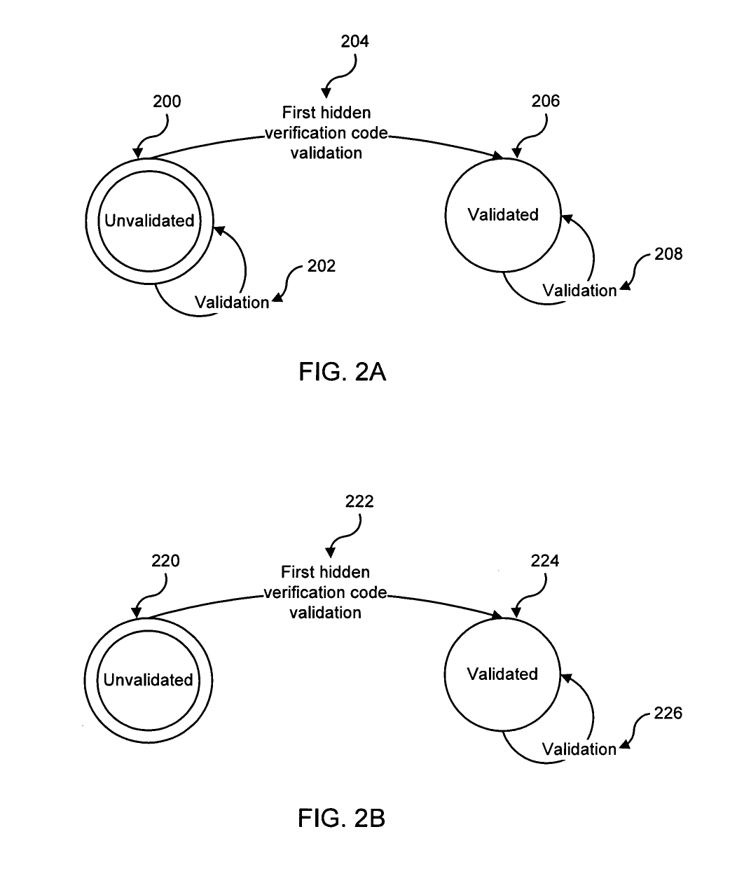

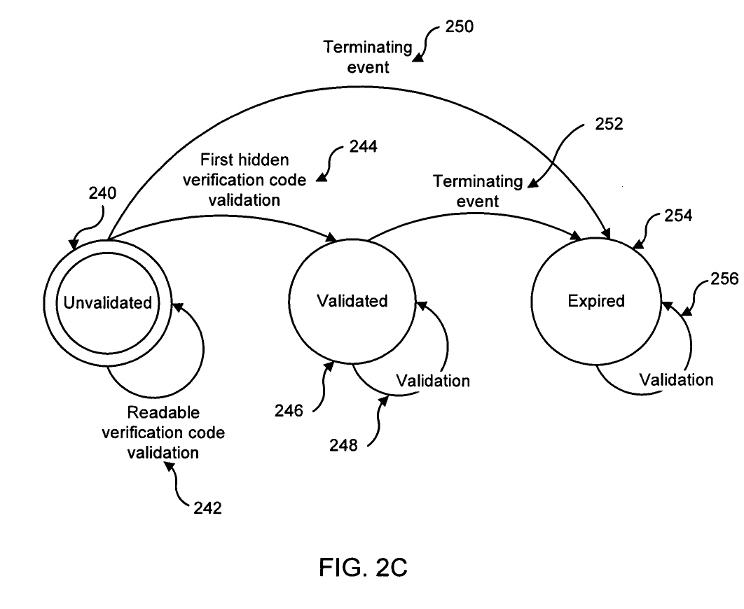

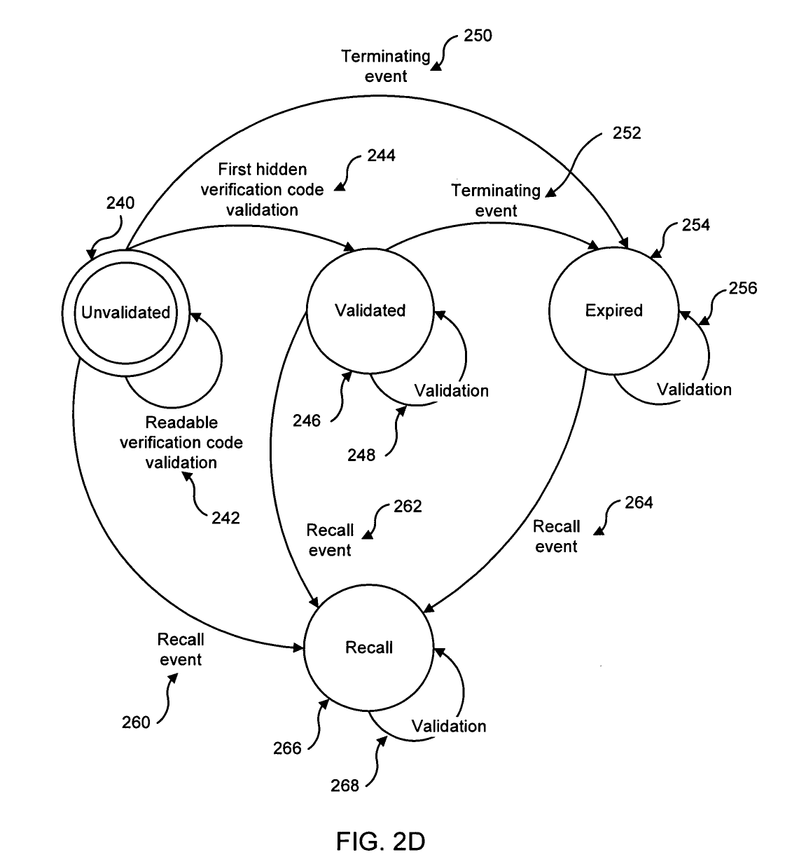

FIG. 2A shows a state diagram of a readable verification code. In this embodiment, a readable verification code starts out in an unvalidated state 200. While it is in state 200, all validation requests 202 would be processed and the readable verification code remains in state 200.

On the first successful validation of the corresponding hidden verification code 204, the state of the readable verification code is transitioned to a validated state 206, where subsequent validations 208 are processed and the readable verification code remains in the validated state 206.

In response to a successful validation 202, the validation service can indicate that the verification code is valid but confirmation would require validating the additional hidden verification code after purchase. For validations 208, the validation service can indicate that the verification code has been previously validated and is no longer valid for an item that is brand new. A multiple-use readable verification code is thus implemented.

FIG. 2B shows a state diagram of a hidden verification code. In this embodiment, a hidden verification code starts out in an unvalidated state 220. On the first successful validation of the hidden verification code 222, the state of the hidden verification code as well as the state of the corresponding readable verification code is transitioned to a validated state 224, where subsequent validations 226 are processed and the hidden verification code remains in the validated state 224.

In response to a successful validation 222, the validation service can indicate that the verification code is valid and good for an item that is brand new. For validations 226, the validation service can indicate that the verification code has been previously validated and is no longer valid for an item that is brand new. A multiple-use hidden verification code is thus implemented.

Additional State Transitions

FIG. 2C shows how a set of states may be used to create expiring readable and hidden verification codes. In this embodiment, the readable and hidden verification codes start out in an unvalidated state 240. While in this state, validations of the readable verification code are processed as step 242 with no change in state.

On the first successful validation of the hidden verification code 244, the state of the readable and hidden verification codes is transitioned to a validated state 246, where subsequent validations 248 are processed and the verification code remains in the validated state 246. A terminating event 250 and another terminating event 252, such as product expiry, may transition the verification codes to an expired state 254. Terminating event 250 and terminating event 252 do not have to be the same. In the expired state 254, validations 256 are processed and the verification codes remain in the expired state 254. For validations 256, the validation service will provide the expired state indicator for the verification code.

Transitioning on Time and Number of Validations

In FIG. 2C, different types of verification codes are created by the choice of terminating events 250 and 252. A type of time-limited verification codes may have the terminating events 250 and 252 occurring when a fixed time is reached. Such a time-limited verification code may be useful for consumables such as pharmaceuticals where the product expires at a fixed time from when the product was manufactured.

A count-limited verification code is created if terminating event 250 is eliminated and terminating event 252 occurs after a fixed number of validations 248 of any combination of the readable and the hidden verification codes have been performed while in the validated state 246. Count-limited verification codes may be useful for situations where there are well-defined workflows that have validations occurring at fixed junctures.

Incorporating a Recall State

FIG. 2D shows the same state diagram in FIG. 2C with a recall state incorporated. The states and steps from 240 to 256 have been reproduced from FIG. 2C without modification, and all descriptions of FIG. 2C still apply. Recall state 266, steps 260-264, and step 268 have been added.

In this embodiment, if the manufactured item is discovered to be compromised while the readable and the hidden verification codes are in the unvalidated state 240, a recall event 260 may transition the readable and the hidden verification codes to a recall state 266 where validations 268 will be processed without any change in verification code state. For validations 268, the validation service may indicate that a recall for the item is in effect, and the embodiment can provide further instructions.

If the item is discovered to be compromised after the verification codes have been validated (state 246), a recall event 262 may transition the verification code to the recall state 266 where validations 268 will be processed without any change in verification code state.

If the item is discovered to be compromised after the verification codes have expired (state 254), a recall event 264 may transition the verification code to the recall state 266 where validations 268 will be processed without any change in verification code state.

Although FIGS. 2C and 2D show that the unvalidated state 240 and the validated state 246 may both transition to an expired state 254 and a recall state 266, it should be understood that the unvalidated state 240 and the validated state 246 may also transition to additional and other types of states, such as advise and invalid, for instance.

Manufacturers can decide on the state transitions allowed and the type of verification code that is appropriate for their needs.

Processing a Validation Request

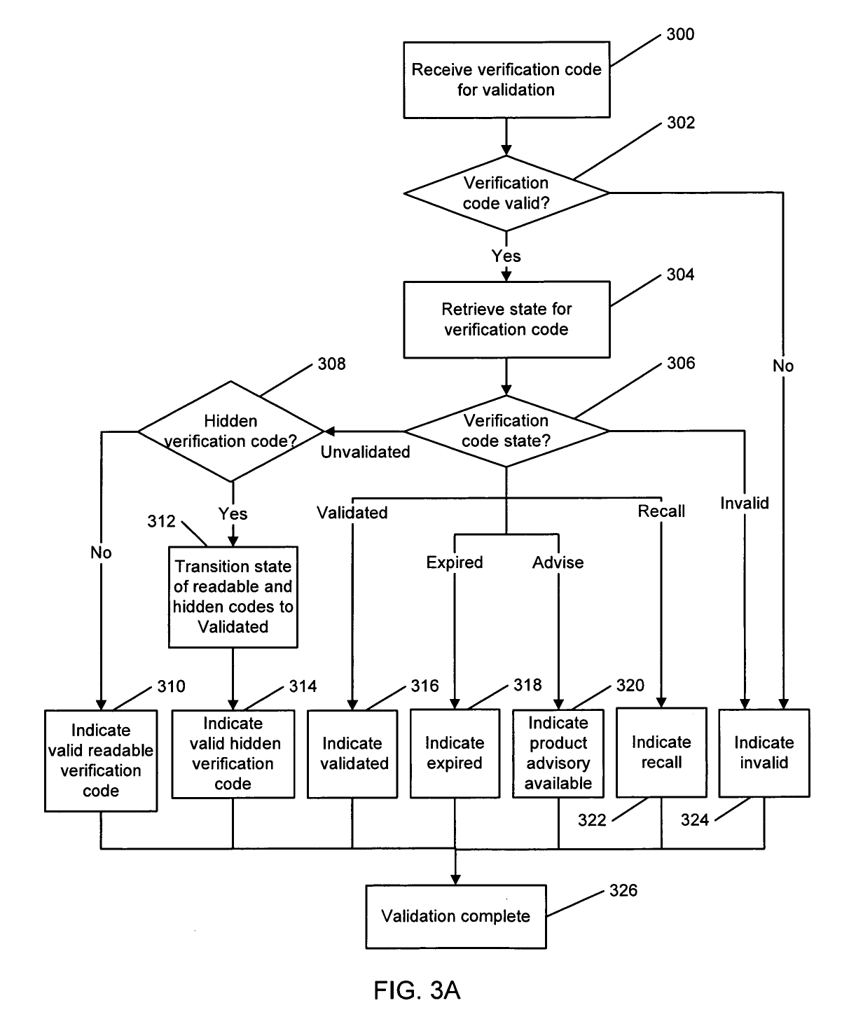

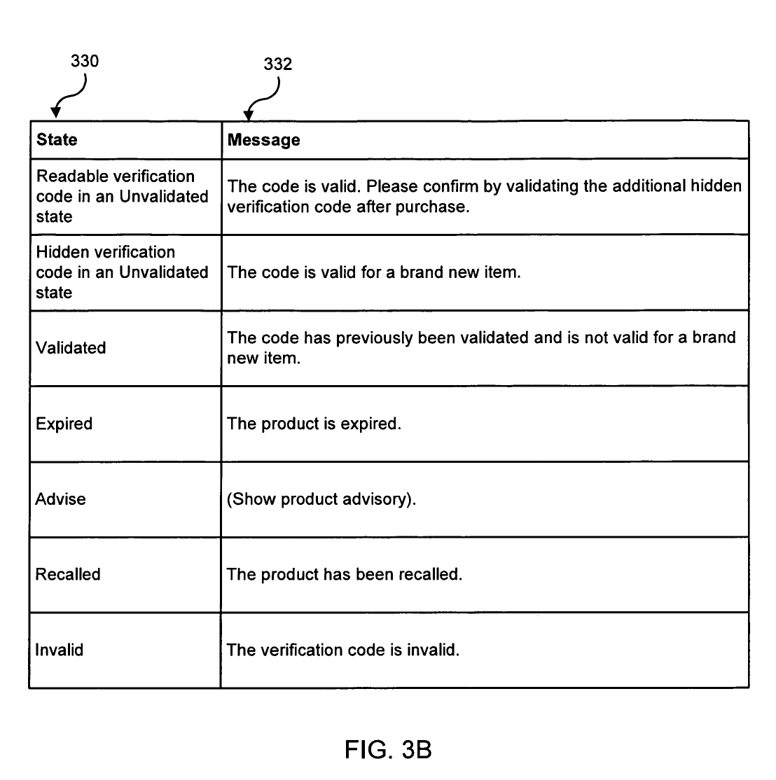

FIG. 3A is a flowchart that shows how a validation service in an embodiment may process a validation request. A validation request for a verification code (readable or hidden) is received (block 300). Checks are made to see that the verification code is valid (block 302). These checks may include seeing that the verification code is in the range of the verification code generation functions, that it passes all the format checks, if any, that were built in (e.g. checksum and parity bits discussed below), and that the verification code was previously provisioned (e.g., it was generated previously, associated with an item, and stored in the validation database). If it is invalid, an invalid code is indicated (block 324) and the validation completes (block 326). Otherwise, the state for the verification code is retrieved (block 304). This may be accomplished with a database lookup using the verification code as the key.

The retrieved verification code state is then determined (block 306). If the state is unvalidated, a check is made to see if the code is a hidden verification code (block 308). If not, an indicator corresponding to a valid readable verification code is returned to the requester (block 310) and the request completes (block 326). If the verification code is a hidden verification code, the state for both the readable and hidden verification codes is transitioned to the validated state (block 312), an indicator corresponding to a valid hidden verification code is returned (block 314), and the request completes (block 326).

For the remaining states, an indicator corresponding to the state is returned (blocks 316 to 324). The validation then completes (block 326).

If appropriate, additional state transitions may also occur during processing of a validation request (not shown). For example, if an embodiment of FIG. 2C above implements a time-limited verification code, then processing of a validation while a verification code is in the unvalidated state 308 and validated state 316 may be preceded by a time check to see if the terminating event 250 and 252 should be triggered. If so, the verification code is transitioned to the expired state 254, and the indicator for the expired state 318 is returned.

Messages as Indicators for Different Verification Code States

FIG. 3B is a table showing examples of messages that may be returned by the validation service in response to a validation request in an embodiment. For each verification code state listed in column 330, there is a corresponding message in column 332 that can be returned to the user.

Generation of Verification Codes

There are numerous methods for generating verification codes. A lengthy code will be an impediment to undesired guessing, yet the code needs to be short enough for a user to submit. Ten to twenty characters may be acceptable. The codes should not be in any predictable order, and they should ideally be scattered throughout the range of the code generation functions. Hash functions such as the Secure Hash Algorithm (SHA) family of functions, and encryption functions such as Data Encryption Standard (DES) and 3DES may be used, separately or in combination, and an additional check to verify uniqueness may be performed. If desired, a string distance algorithm can also be run to see that the generated codes are sufficiently different from other existing codes.

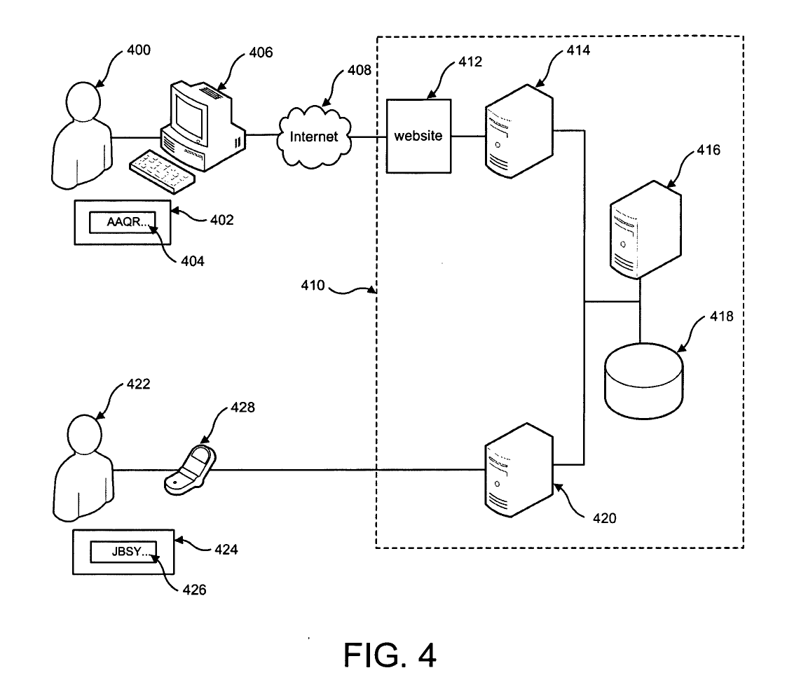

To increase the density of the information packed into the verification code, binary output can be represented in base 36 for a case-insensitive alphanumeric numeral system (A-Z and 0-9), or base 64 (A-Z, a-z, 0-9+2 additional characters) for a case-sensitive system. Base 36 or lower is suggested if telephone validation (discussed with FIG. 4 below) is expected.

To aid validity checks and to thwart guessing, encrypted codes of known information may be injected into the verification code for decryption and comparison during validation. Checksums and parity bits may also be injected for this purpose.

The readable and the hidden verification code may also be machine readable, in a form such as a barcode or an RF tag, either in isolation or in conjunction with a human readable alphanumeric sequence of characters. This may be a convenient option if machine readers are available.

Supplying the Readable and Hidden Verification Codes With the Manufactured Item

The readable verification code may be printed and attached as a tag or applied as a label.

Hiding the hidden verification code can be achieved by placing the code with the item and enclosing both in opaque packaging. If the hidden verification code is to be attached externally, it can be placed within a sealed envelope, or it can be covered with opaque and tamper-evident material.

As used herein, the term manufactured item includes any type of article or device that is made or manufactured. The term can also apply to containers that may be used for shipping the one or more manufactured items, for example. In such an embodiment, a verification code may be used to protect the contents of the container.

Submitting a Validation Request

FIG. 4 is a block diagram illustrating an anti-counterfeit and product safety system according to one exemplary embodiment. The anti-counterfeit and product safety system includes manufactured or protected items 402 and 424 that have been supplied with a readable and/or hidden verification codes 404 and 426, and a validation service 410 that validates the verification codes 404 and 426 for users 400 and 422. According to the exemplary embodiment, validation takes place with users 400 and 422 submitting one or both of the readable and hidden verification codes 404 and 426 to the validation service 410.

FIG. 4 shows two exemplary avenues that can be provided to allow users 400 and 422 to validate verification codes. In one embodiment, a user 400, who wishes to check on a readable or a hidden verification code 404 that was supplied with a protected item 402, may use a web browser on a computer 406 to navigate through the internet 408 to a validation section on a manufacturer's or a validation service's website 412. The user 400 then submits the verification code 404.

A web or application server 414 then performs a check with a validation system 416 to validate the provided verification code. Validation system 416 includes a software application executing (not shown) on a processor that may use a database 418 as part of processing. A validation result is then returned to user 400 via a web page, for example.

In another embodiment, a user 422, who wants to check on a readable or a hidden verification code 426 that was supplied with an item 424, may use a phone 428 to place a call to the manufacturer or the validation service 410 where an automated phone system 420 services the call. User 422 enters the verification code 426 when prompted, and the automated phone system 420 performs a check with the validation system 416 to validate the provided verification code. The validation result can then be read back to user 422, via audio.

While not shown, other possible avenues for validation may be implemented. These may include an interactive voice response system, a live representative, transmission of a photographic image such as a barcode, and electronic data transmission.

State Maintenance and Tracking of Verification Codes

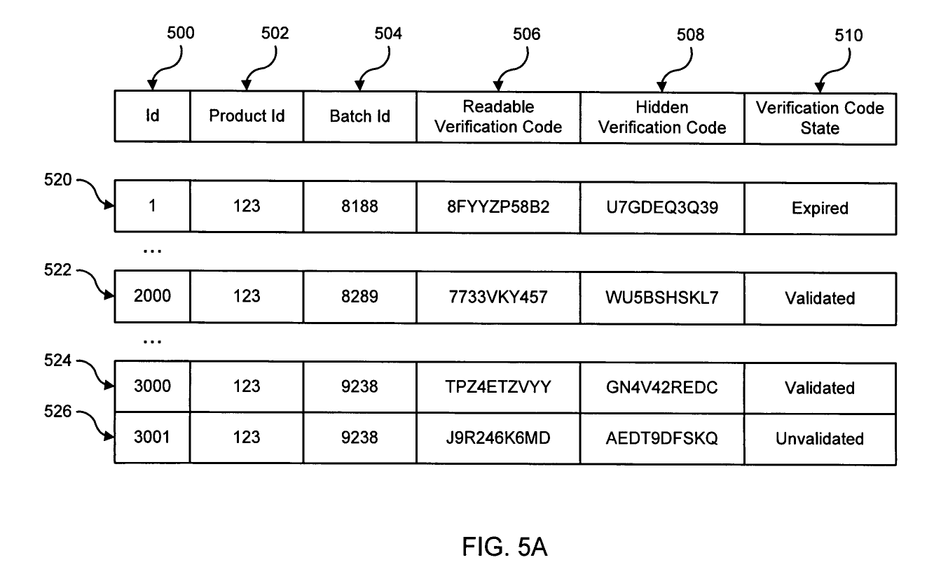

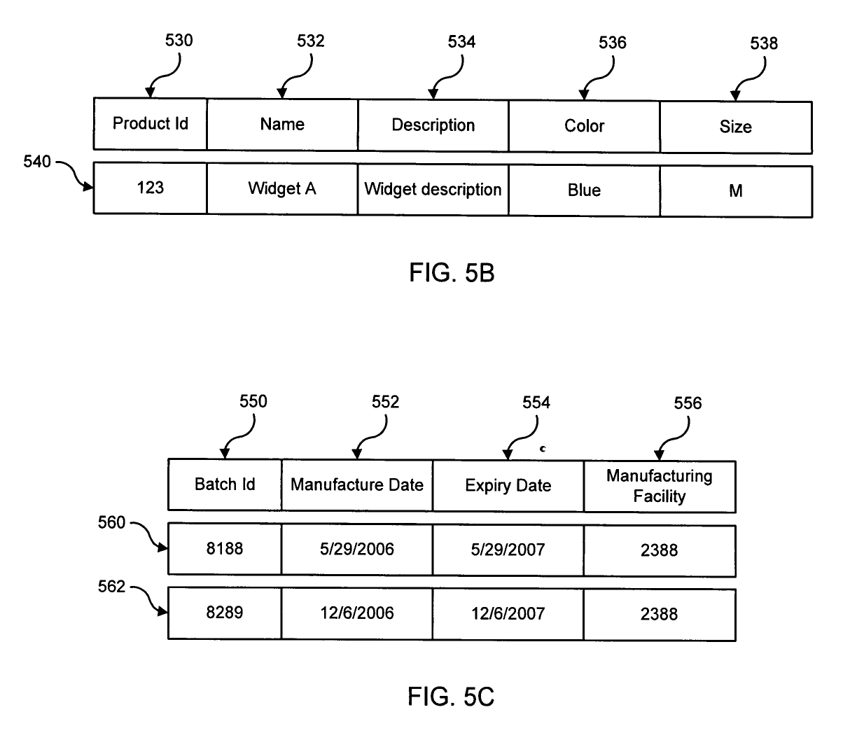

FIGS. 5A-C show examples of a database tables that can be used to track the state of verification codes and to aid processing of validations.

FIG. 5A is an example of a database table that can be used to track verification codes.

Field Id 500 is for an identity key that serves as the primary key for the example table. Field Product Id 502 is for a product identifier which is a foreign key into a Product table (shown as FIG. 5B and described below) where product-specific data such as the product name, the product description, the make, model, color, size, the list of ingredients, and the active ingredient concentrations for a manufactured item can be retrieved. Field 504 is for a batch identifier which is a foreign key into a Batch table (shown as FIG. 5C and described below) where batch-specific data such as the date of manufacture, the expiry date, and manufacturing facility for the batch of items that a manufactured item belongs to can be retrieved. Additional fields can be added to the example table in FIG. 5A to hold item-specific information such as serial numbers and validation dates (not shown). Example rows of data for this sample table are shown as 520-526.

Field Readable Verification Code 506 and field Hidden Verification Code 508 hold the readable, and the corresponding hidden verification code portions of a readable/hidden verification code pair respectively. In this embodiment, field 510 holds the shared verification code state for the readable/hidden verification code pair.

Since the readable and hidden verification codes are substantially unique, two database indexes can be created, one for the Readable Verification Code field 506 and another for the Hidden Verification Code field 508. Given a verification code, whether the code is readable or hidden can be determined by first searching with one index, and if the code is not found, by searching the other index. Once found, a unique row in the database table shown in FIG. 5A can be retrieved, which would then give access to product-specific information through the product id field 502, batch-specific information through the batch id field 504, and item-specific information such as the serial number and the validation date if such fields are added to the example table in FIG. 5A.

FIG. 5B is an example of a database table that can be used to store product-specific information. Field Product Id 530 holds a product identifier for the primary key. Rows in this table may be referenced by the Product Id field 502 in the database table shown in FIG. 5A. For example, Product Id 123 in FIG. 5A data row 520 references Product Id 123 in FIG. 5B data row 540. Fields 532-538 are exemplary columns that store product-specific information, and data row 540 is an example.

FIG. 5C is an example of a database table that can be used to store batch-specific information. Field Batch Id 550 holds a batch identifier for the primary key. Rows in this table may be referenced by the Batch Id field 504 in the database table shown in FIG. 5A. For example, Batch Id 8188 in FIG. 5A data row 520 references Batch Id 8188 in FIG. 5C data row 560. Fields 552-556 are exemplary columns that store batch-specific information, and data rows 560-562 are examples.

Requiring Additional Information For Validation for Increased Security

The manufacturer or validation service can choose in an embodiment to require the user submit other information about the manufactured item along with the verification code when a validation is requested. This additional information requested can include product-specific information such as the part number, the make, model, size, and color, batch-specific information such as a batch identifier, or item-specific information such as the serial number. This additional information can then be required to match as well as part of validation to increase the difficulty for a match and to thwart guessing.

The manufacturer or validation service can also choose in an embodiment to require the user submit the readable verification code along with the hidden verification code when a hidden verification code is submitted for validation.

Additional Information Indicated on Successful Validation for Reinforcement

In addition to the state-dependent indicators that are provided to the user on validation (such as the messages described with FIG. 3B), the manufacturer or validation service can choose in an embodiment to also return information related to the manufactured item on successful validation for additional reinforcement, and to help guard against product relabeling and label tampering. This may be any combination of information that is unique to the manufactured item such as a serial number, information that is unique to a batch of items such as a batch number or expiry date, and information that may or may not be unique to the product such as the name and description, the model number, the model color, the ingredient list, or the active ingredient concentrations. Photographic images or drawings may be shown as well, and these too may or may not be unique to the manufactured item. By providing such information, users can confirm for themselves, and any discrepancies can be further investigated or reported, or they may be grounds for rejecting the item.

Security—Validation Limits

Temporary validation blocks may be imposed on a user after some number of failed validation attempts. This would stop attempts to guess at verification codes.

Roles

It should not be taken as a limitation that the manufacturer is the entity that:
1. Generates the verification codes.
2. Associates the verification codes with the item.
3. Provides the validation service.
4. Maintains the state of the verification codes.
   Where feasible, these different tasks and roles, in whole or in part, can be provided or undertaken by any entity. This may include representatives and agents of the manufacturer, and third parties.

A method and system for providing anti-counterfeit and product safety to manufactured items have been disclosed. Product relabeling, label tampering, counterfeiting and other product safety threats are countered by providing two substantially unique verification codes with each manufactured item, transitioning the state of the verification codes on key events, allowing a user to check on the state of the verification codes, and in one embodiment, obtain additional information about the item.

For the user, validation of the verification codes is easy and it does not require any specialized scanners or hardware. A protected item that is sold without verification codes, or has verification codes that do not validate correctly will raise a flag, and the item can be rejected or returned.

The manufacturer gains protection from product relabeling, label tampering and counterfeiting, and they also have an avenue to disseminate information about the item after it has been released or sold. Any manufactured item can be protected with this method.

The present invention has been described in accordance with the embodiments shown, and one of ordinary skill in the art will readily recognize that there could be variations to the embodiments, and any variations would be within the spirit and scope of the present invention. For example, the names associated with the various states and their transitions may be changed and still fall with the scope of the present invention. The present invention can be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

What is claimed is:

1. A method for providing anti-counterfeit and product safety to a manufactured item comprising:
supplying two substantially unique verification codes with the manufactured item, wherein a first verification code is readable and a second verification code is hidden, and wherein both verification codes are initialized to a first state in a database accessible to a validation service;
allowing a user to submit the readable verification code to a validation service a plurality of times;
in response to the validation service receiving the readable verification code for validation, providing the user with an indicator of a current state of the readable verification code;
allowing a user to expose the hidden verification code and to submit the hidden verification code to the validation service a plurality of times;
in response to the validation service receiving the hidden verification code for validation, providing the user with an indicator of the current state of the hidden verification code;
and using a first successful validation of the hidden verification code as an event that triggers a state transition of both the readable and the hidden verification codes from the first state to a second state.

2. The method of claim 1 wherein the first state of the readable and the hidden verification codes is one of: unconfirmed, unexpired, unsold, unvalidated, unverified, and valid.

3. The method of claim 1 wherein the second state of the readable and the hidden verification codes is one of: confirmed, expired, sold validated, verified and invalid.

4. The method of claim 1 wherein the readable verification code is any combination of: an RF tag, a barcode, and an alphanumeric sequence of characters.

5. The method of claim 1 wherein the hidden verification code is any combination of: an RF tag, a barcode, and an alphanumeric sequence of characters.

6. The method of claim 1 wherein in response to the validation service receiving a readable verification code that is in the first state further comprises providing the user with an indicator that confirmation will require validation of the hidden verification code.

7. The method of claim 1 wherein the first state of the readable and the hidden verification codes is transitioned to a third state after one of: a period of time from being initialized to the first state, a period of time up to a fixed time, a fixed number of validations while in the first state, and on discovery of a problem; and wherein the third state is one of: advise, recall, expired, and invalid.

8. The method of claim 1 wherein the second state of the readable and the hidden verification codes is further transitioned to a third state after one of: a period of time from entry into the second state, a period of time up to a fixed time, a fixed number of validations while in the second state, and on discovery of a problem; and wherein the third state is one of: advise, recall, expired, and invalid.

9. The method of claim 1 wherein submitting the readable verification code to the validation service further comprises submitting additional information about the manufactured item comprising any combination of: product specific information, batch specific information, and item specific information.

10. The method of claim 1 wherein submitting the hidden verification code to the validation service further comprises submitting additional information about the manufactured item comprising any combination of: the readable verification code, product specific information, batch specific information, and item specific information.

11. The method of claim 1 wherein providing the user with an indicator of the current state in response to the validation of either the readable or the hidden verification code further comprises providing information to the user that is any combination of being: product specific, batch specific and item specific.

12. The method of claim 1 wherein allowing the user to expose the hidden verification code is one of: as a condition of purchase, after purchase, after taking possession, before use, and before consumption.

13. The method of claim 1 wherein receiving by a validation service a plurality of submissions of the readable and the hidden verification codes for validation is done through one of: a website, an automated phone system, an interactive voice response system, a live representative, transmission of a photographic image, and electronic data transmission.

14. An anti-counterfeit and product safety system, comprising:
a readable verification code and a hidden verification code that are supplied with a manufactured item;
a validation service, the validation service including a database for storing states associated with the readable verification code and the hidden verification code, wherein the states associated with readable and the hidden verification codes are initialized to a first state in the database;
an application executing on a processor that is functional for:
in response to receiving the readable verification code through the validation service, returning an indication of a current state of the readable verification code from the database,
in response to receiving the hidden verification code through the validation service, returning an indication of the current state of the hidden verification code from the database, and
transitioning the state of the readable and the hidden verification codes to a second state and storing the second state in the database after receiving the hidden verification code for the first time.

15. The system of claim 14 wherein the first state in the database is one of: unconfirmed, unexpired, unsold, unvalidated, unverified, and valid.

16. The system of claim 14 wherein the second state in the database is one of: confirmed, expired, sold, validated, verified, and invalid.

17. The system of claim 14 wherein the readable verification code is any combination of: an RF tag, a barcode, and an alphanumeric sequence of characters.

18. The system of claim 14 wherein the hidden verification code is any combination of: an RF tag, a barcode, and an alphanumeric sequence of characters.

19. The system of claim 14 wherein in response to receiving the readable verification code which is in the first state further comprises returning an indication that confirmation will require validation of the hidden verification code.

20. The system of claim 14 wherein the first state of the readable and the hidden verification codes is transitioned to a third state after one of: a period of time from being initialized to the first state, a period of time up to a fixed time, a fixed number of validations while in the first state, and on discovery of a problem; and wherein the third state is one of: advise, recall, expired, and invalid.

21. The system of claim 14 wherein the second state of the readable and the hidden verification codes is transitioned to a third state after one of: a period of time from entry into the second state, a period of time up to a fixed time, a fixed number of validations while in the second state, and on discovery of a problem; and wherein the third state is one of: advise, recall, expired, and invalid.

22. The system of claim 14 wherein receiving the readable verification code through the validation service further comprises receiving additional information about the manufactured item comprising any combination of: product specific information, batch specific information, and item specific information.

23. The system of claim 14 wherein receiving the hidden verification code through the validation service further comprises receiving additional information about the manufactured item comprising any combination of: the readable verification code, product specific information, batch specific information, and item specific information.

24. The system of claim 14 wherein returning an indication of the current state further comprises returning information that is any combination of being: product specific, batch specific and item specific.

25. The system of claim 14 wherein receiving the readable and the hidden verification codes is through one of: a website, an automated phone system, an interactive voice response system, a live representative, transmission of a photographic image, and electronic data transmission.
